(19) United States
(12) Patent Application Publication
(10) Pub. No.: US 2024/0286108 A1
(43) Pub. Date: Aug. 29, 2024

(54) CARBON DIOXIDE ADSORBENT, MANUFACTURING METHOD OF THE SAME, DEVICE AND PROCESS USING THE SAME

(71) Applicant: KOREA INSTITUTE OF ENERGY RESEARCH, Daejeon (KR)

(72) Inventors: Jong-ho PARK, Daejeon (KR); Hyung Jin YOON, Daejeon (KR); Hee-tae BEUM, Daejeon (KR); Sang-sup HAN, Daejeon (KR); Jongkee PARK, Daejeon (KR); Ko-yeon CHOO, Daejeon (KR)

(73) Assignee: KOREA INSTITUTE OF ENERGY RESEARCH, Daejeon (KR)

(21) Appl. No.: 18/643,070

(22) Filed: Apr. 23, 2024

(30) Foreign Application Priority Data
Feb. 28, 2023 (KR) 10-2023-0027169

(51) Int. Cl. B01J 20/16; B01D 53/047; C01B 3/56

(52) U.S. Cl. CPC B01J 20/165; B01D 53/047; C01B 3/56; B01D 2253/1085; B01D 2256/16; B01D 2257/504; C01B 2203/0233; C01B 2203/0283; C01B 2210/0018; C01B 2210/0051

(57) ABSTRACT

The present invention is to provide a carbon dioxide adsorbent that can collect carbon dioxide generated during a natural gas reforming process at a high concentration and has an excellent adsorption working capacity, a manufacturing method of the same, and a device and process using the same. The carbon dioxide adsorbent according to various examples of the present invention is characterized by including X-type or Y-type zeolite in which at least a part of alkali metal cations or alkali earth metal cations is replaced with H⁺ ions.

### BACKGROUND OF THE INVENTION

### Field of the Invention

Various examples of the present invention relate to a carbon dioxide adsorbent, a manufacturing method of the same, and a device and process using the same. Specifically, various examples of the present invention relate to a carbon dioxide adsorbent for collecting carbon dioxide generated during a natural gas reforming process at a high concentration, a manufacturing method of the same, and a device and process using the same.

### Description of the Related Art

Due to the problems of greenhouse gas emissions and global warming, the need to develop and spread new and renewable energy that can replace fossil fuels is increasing, and hydrogen, which is a clean energy source, is attracting attention. Hydrogen has a high energy density, so importance thereof as a future energy source is increasing. Hydrogen production methods are divided into production using fossil fuel reforming reaction, which is a traditional method, and production using biomass and water, which are renewable methods. Hydrogen production using fossil fuels can be performed by thermochemical methods such as wet reforming reaction, autothermal reforming reaction, partial oxidation reaction, and gasification reaction. In the hydrogen market, hydrogen produced through reformers account for 70% or more of the total market.

Currently, in case of hydrogen produced through natural gas steam reforming (extracted hydrogen), 8 to 12 kg of carbon dioxide is emitted per kg of the hydrogen production amount. Therefore, in order to extract hydrogen in an environment-friendly manner, it is required to reduce the amount of carbon dioxide generated during hydrogen extraction.

The demand for carbon dioxide adsorbents with excellent adsorption working capacities is increasing to collect CO₂ generated during the extracted hydrogen production process.

### SUMMARY OF THE INVENTION

The present invention is conceived in consideration of the above problems, and an object thereof is to provide a carbon dioxide adsorbent that can collect carbon dioxide generated during a natural gas reforming process at a high concentration and has an excellent adsorption working capacity, a manufacturing method of the same, and a device and process using the same.

The carbon dioxide adsorbent according to various examples of the present invention is characterized by including X-type or Y-type zeolite in which at least a part of alkali metal cations or alkali earth metal cations is replaced with H⁺ ions.

The manufacturing method of a carbon dioxide adsorbent according to various examples of the present invention may include: a step of dispersing NaY in distilled water; a step of dispersing ammonium chloride (NH₄Cl) in the NaY dispersed in distilled water; a step of washing the mixture in the dispersing step with distilled water; a step of drying the adsorbent washed in the washing step; and a step of calcining the adsorbent dried in the drying step.

The device according to various examples of the present invention is characterized by including a steam methane reforming (SMR) device for reforming methane into steam; a water gas shift (WGS) device in which carbon monoxide-containing gas and steam provided from the SMR device react with each other; a first pressure swing adsorption (PSA) device that separates carbon dioxide and hydrogen generated from the WGS device to generate high-purity hydrogen; and a second pressure swing adsorption (PSA) device that collects carbon dioxide by being provided with carbon dioxide from at least one of the SMR device and the first PSA device, in that the second PSA device is filled with the carbon dioxide adsorbent, and the carbon dioxide adsorbent includes X-type or Y-type zeolite in which at least a part of alkali metal cations or alkali earth metal cations is replaced with H⁺ ions.

The method according to various examples of the present invention is characterized by including a steam methane reforming (SMR) process of reforming methane into steam; a water gas shift (WGS) process in which carbon monoxide-containing gas and steam provided from the SMR device react with each other; a first pressure swing adsorption (PSA) process for generating high-purity hydrogen by separating carbon dioxide and hydrogen generated from the WGS device; and a second pressure swing adsorption (PSA) process for collecting carbon dioxide by being provided with carbon dioxide generated from at least one of the SMR process and the first PSA process, in that the carbon dioxide adsorbent is used in the second PSA process, and the carbon dioxide adsorbent includes X-type or Y-type zeolite in which at least a part of alkali metal cations or alkali earth metal cations is replaced with H⁺ ions.

### BRIEF DESCRIPTION OF THE DRAWINGS

FIG. 1 is a graph showing results of carbon dioxide adsorption isotherms at 25° C. for Samples 1 to 4 of an example;

FIG. 2 is a graph representing an example of adsorption isotherms of typical adsorbents;

FIG. 3 is a graph showing results carbon dioxide adsorption isotherms at 25° C. for Samples 11 to 18; and

FIG. 4 shows the results showing working capacities in a pressure swing range of 100 to 400 kPa according to degrees of ion exchange.

### DETAILED DESCRIPTION OF THE PREFERRED EMBODIMENTS

Hereinafter, various examples of this document are described with reference to the attached drawings. The examples and terms used herein are not intended to limit the technology described in this document to specific embodiments, and should be understood to include various modifications, equivalents, and/or replacements of the examples.

The carbon dioxide adsorbent according to various examples of the present invention is characterized by including X-type or Y-type zeolite in which at least a part of alkali metal cations or alkali earth metal cations is replaced with H⁺ ions.

Here, ions of alkali metal or alkali earth metal may include Li ions, Na ions, K ions, Mg ions, or Ca ions.

More specifically, the carbon dioxide adsorbents according to various examples of the present invention can be expressed by Formula 1 or Formula 2 below.

### [Formula 1]

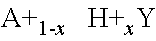

where, A is an alkali metal or alkali earth metal, and 0<x<1.

### [Formula 2]

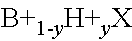

where, B is an alkali metal or alkali earth metal, and 0<y<1.

The Si/Al ratio of the carbon dioxide adsorbent may be 1 to 100.

According to an example, the carbon dioxide adsorbent according to various examples of the present invention is characterized in that at least a part of Na⁺ ions in NaY are replaced with H⁺ ions.

That is, the carbon dioxide adsorbent may have Formula 3 below.

### [Formula 3]

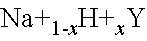

where, 0<x<1.

Specifically, the carbon dioxide adsorbent according to various embodiments of the present invention is at least one selected from the group consisting of Na⁺_{0.82}H⁺_{0.18}Y, Na⁺_{0.53}H⁺_{0.47}Y, and Na⁺_{0.18}H⁺_{0.82}Y.

The carbon dioxide adsorbent of the present invention can provide an adsorbent with excellent working capacities in a given pressure swing range by controlling the Na⁺/H⁺ ratio by ion-exchanging a part of the Na⁺ ions of NaY with H⁺ ions.

The Na⁺₁₋ₓ H⁺ₓY-based adsorbent manufactured in the present invention has excellent working capacities and can be mixed with other commercially available adsorbents, and more efficient carbon dioxide separation can be performed when the adsorbent is mixed. The adsorbent can easily adsorb and be regenerated under low temperature, and the improvement of the adsorption rate can be achieved by providing heat when being mixed with a commercially available adsorbent having a high heat of adsorption.

The carbon dioxide adsorbent of the present invention can be manufactured through an ion exchange method to replace Na⁺ ions in the NaY adsorbent. Specifically, the manufacturing method of a carbon dioxide adsorbent of the present invention includes a step of dispersing NaY in distilled water; a step of dispersing ammonium chloride (NH₄Cl) in the NaY dispersed in distilled water; a step of washing the mixture in the dispersing step with distilled water; a step of drying the adsorbent washed in the washing step; and a step of calcining the adsorbent dried in the drying step.

Here, NaY may be NaY from which impurities such as moisture are removed in a vacuum.

In the step of dispersing ammonium chloride (NH₄Cl), ammonium chloride can be used in a specific ratio with respect to Na⁺ ions in NaY. For example, ammonium chloride that causes the mass ratio of NaY/ammonium chloride to be a concentration of 0.01 to 4 may be used.

Next, in the step of washing with distilled water, the washing can be performed through vacuum filtering. Here, the amount of distilled water used may be 2 to 5 times in mass ratio with respect to the distilled water used in the dispersing step. If the amount of distilled water is less than 2 times, impurities may not be sufficiently removed, and if the amount is more than 5 times, the washing may also affect the removal of the ions in the adsorbent. Preferably, the amount of distilled water used in the washing step may be three times that of the distilled water used in the dispersing step.

Next, in the step of drying the washed adsorbent, the adsorbent may be dried in a vacuum oven. Drying temperature may be 100° C. to 140° C. If the drying temperature is less than 100° C., removal of impurities such as moisture may not be performed, and if the temperature is more than 140° C., the pore structure in the adsorbent may be damaged due to rapid removal of moisture. Preferably, the drying temperature may be 120° C.

Next, the step of calcining may be conducted at a high temperature to transfer ammonium ions in the dried adsorbent to hydrogen ions. Here, the calcination temperature may be 250° C. to 400° C. If the calcination temperature is less than 250° C., smooth transfer of ammonium ions to hydrogen ions in the dried adsorbent may be difficult, and if the temperature is more than 400° C., the pore structure in the adsorbent may be damaged. Preferably, the calcination temperature may be 350° C.

The carbon dioxide adsorbent described above may be used in a carbon dioxide pressure swing adsorption (PSA) device.

Specifically, a device according to various examples of the present invention may include a steam methane reforming (SMR) device for reforming methane into steam; a water gas shift (WGS) device in which carbon monoxide-containing gas and steam provided from the SMR device react with each other; a first pressure swing adsorption (PSA) device that separates carbon dioxide and hydrogen generated from the WGS device to generate high-purity hydrogen; and a second pressure swing adsorption (PSA) device that collects carbon dioxide by being provided with carbon dioxide from at least one of the SMR device and the first PSA device.

Here, the carbon dioxide adsorbent described above can be used in the second PSA device that collects carbon dioxide. The carbon dioxide adsorbent described above may be used alone. Alternatively, the carbon dioxide adsorbent of the present invention described above and a commercially available adsorbent may be used in combination. That is, the carbon dioxide adsorbent filled in the second PSA device may include a first adsorbent in which at least a part of Na⁺ ions in NaY are replaced with H⁺ ions; and a second adsorbent that is at least one of NaX and NaY.

The carbon dioxide adsorbent described above can be used in a carbon dioxide pressure swing adsorption (PSA) process.

Specifically, a process according to various examples of the present invention may include a steam methane reforming (SMR) process of reforming methane into steam; a water gas shift (WGS) process in which carbon monoxide-containing gas and steam provided from the SMR device react with each other; a first pressure swing adsorption (PSA) process for generating high-purity hydrogen by separating carbon dioxide and hydrogen generated from the WGS device; and a second pressure swing adsorption (PSA) process for collecting carbon dioxide by being provided with carbon dioxide generated from at least one of the SMR process and the first PSA process.

Here, the carbon dioxide adsorbent described above can be used in the second PSA device that collects carbon dioxide. The carbon dioxide adsorbent described above may be used alone. Alternatively, the carbon dioxide adsorbent of the present invention described above and a commercially available adsorbent may be used in combination. That is, the carbon dioxide adsorbent used in the second PSA device may include a first adsorbent in which at least a part of Na⁺ ions in NaY is replaced with H⁺ ions; and a second adsorbent that is at least one of NaX and NaY.

Hereinafter, the present invention is described in detail with reference to specific examples.

However, the following examples are only for illustrating the present invention, and the present invention is not limited by the following examples.

### EXAMPLE

A NaY adsorbent from which impurities such as moisture were removed in a vacuum at 120° C. was dispersed in distilled water. In order to replace some Na⁺ groups with H⁺ groups, a specific amount of ammonium chloride (NH₄Cl) was dispersed. Here, ammonium chloride was used in various ratios (0<x<100) with respect to Na⁺ ions in the NaY adsorbent.

Washing is performed with distilled water through vacuum filtering. The amount of distilled water used was three times the amount of distilled water used during ion exchange.

After washing, drying was performed in a vacuum oven. Drying was performed at a temperature of 120° C.

In order to transfer the ammonium ions in the dried adsorbent to hydrogen ions, calcination was performed at high temperature. Here, the calcination was performed at 350° C.

Specifically, referring to Table 1 below, Sample 1 is a sample to which NH₄Cl was not added during actual manufacturing. Sample 2 had a mass ratio of NH₄Cl/NaY of 0.07 during actual manufacturing. As a result of analyzing the sample, the composition was Na⁺_{0.82} H⁺_{0.18}Y. Sample 3 had a mass ratio of NH₄Cl/NaY of 0.18 during actual manufacturing. As a result of analyzing the sample, the composition was Na⁺_{0.535}H⁺_{0.47}Y. Sample 4 had a mass ratio of NH₄Cl/NaY of 3.56 during actual manufacturing. As a result of EDS analysis of the sample, the composition was Na⁺_{0.18}H⁺_{0.82}Y.

TABLE 1

| | Result of | | | | | | | NH₄Cl/NaY Mass |
|---|---|---|---|---|---|---|---|---|
| Sample | Analysis of | Atomic percent (%) | | | | | Si/Al | Ratio During |
| No. | Sample | O | Na | Al | Si | Cl | ratio | Manufacturing |
| 1 | Na⁺₁H⁺₀Y | 68.0 | 8.27 | 6.91 | 16.6 | 0.06 | 2.41 | 0 fold |
| 2 | Na⁺_{0.82}H⁺_{0.18}Y | 70.39 | 6.86 | 6.65 | 16.01 | 0.09 | 2.41 | 0.036-fold |
| 3 | Na⁺_{0.53}H⁺_{0.47}Y | 69.33 | 4.38 | 7.62 | 18.56 | 0.11 | 2.43 | 0.18-fold |
| 4 | Na⁺_{0.18}H⁺_{0.82}Y | 73.5 | 1.52 | 7.09 | 17.07 | 0.79 | 2.41 | 3.56-fold |

Referring to Table 1 above, the amount of NH₄Cl ions remaining on the surface can be indirectly confirmed through the Cl residual amount to know that, even in Sample 4 including an excessive amount of ammonium chloride, Cl is almost non-existent. In addition, through the Na atomic ratio, it can be seen that the HY content increases as the loaded amount of ammonium chloride increases. Meanwhile, it can be seen that the change in Si/Al ratio according to the loaded amount of ammonium chloride is not significant.

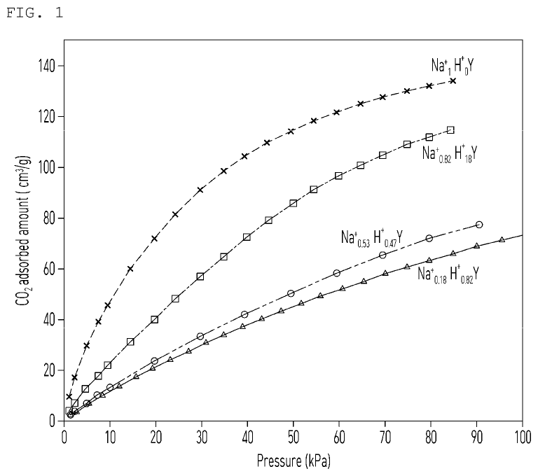

Meanwhile, FIG. 1 is a graph showing results obtained by measuring the carbon dioxide adsorption amount according to pressure at 25° C. for Samples 1 to 4. Referring to FIG. 1, it can be seen that it is possible to provide a carbon dioxide adsorbent having a working capacity greater than that of the adsorbent in the related art in a given pressure swing range by adjusting the Na⁺/H⁺ ratio.

That is, the working capacity is defined as a difference in equilibrium carbon dioxide adsorption capacity over pressure swing operation in the PSA process, and it is possible to use a carbon dioxide adsorbent in which the Na⁺/H⁺ ratio is adjusted according to the desired pressure swing range.

The efficiency of the pressure swing adsorption (PSA) process is significantly affected by the adsorption performance depending on the material of the adsorbent.

Since the pressure swing adsorption (PSA) process separates gas mixtures by using differences in the performance of the adsorbent according to pressure changes, the difference in adsorption performance according to pressure is more important than the adsorbent simply having a high adsorption amount.

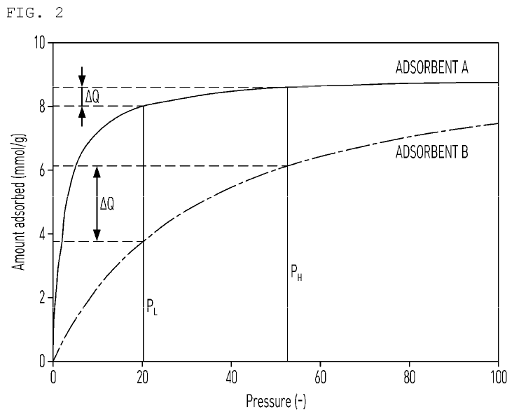

FIG. 2 is a graph representing an example of adsorption isotherms of typical adsorbents;

An adsorbent A shows a higher adsorption amount than an adsorbent B at a same pressure, but when the difference in an adsorption amount (ΔQ) between the two adsorbents is compared in the pressure range of 20 to 50, it can be confirmed that the adsorbent B has a much higher working capacity than A.

In the case of the adsorbent A, the pressure is required to be lowered to a high vacuum in order to show high performance. However, the adsorbent B can easily secure the same level of working capacity even when the pressure is lowered to a relatively lower vacuum. Accordingly, the electricity cost required when operating the VSA (Vacuum Swing Adsorption) process can be reduced. That is, process efficiency can be increased when using the adsorbent B compared to the adsorbent A.

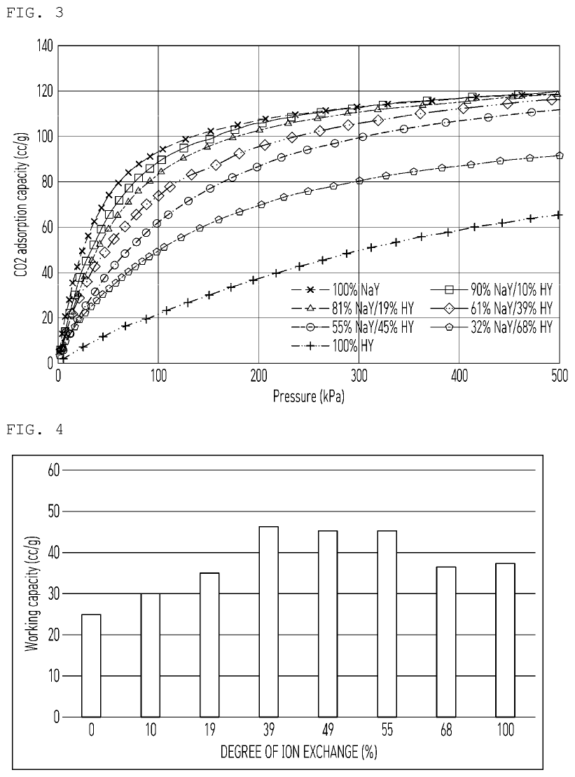

FIG. 3 is a graph showing results obtained by measuring carbon dioxide adsorption amounts according to pressure at 25° C. for Samples 11 to 18 (hereinafter, see Table 2). More specifically, FIG. 3 is a graph showing the results obtained by analyzing the carbon dioxide adsorption isotherm of NaₓH₁₋ₓY zeolite according to the degree of ion exchange at 25° C.

In the example (experiment) in which the same results as those shown in FIG. 3 was deduced, ion exchange was performed to adjust the bond strength between NaY and carbon dioxide, and accordingly, the difference in adsorption amount (working capacity) in the effective pressure fluctuation section of 100 to 400 kPa was maximized.

With reference to FIG. 3, in the case of 100% NaY zeolite (Sample 11), it can be seen that an equilibrium adsorption amount of about 120 cc/g at a pressure of 500 kPa was shown, and in particular, the highest adsorption amount was shown. However, in Sample 11, most of the adsorption capacity changes in the range of 0 to 100 kPa, and in particular, the difference in adsorption amount is not large in the effective pressure range of 100 to 400 kPa, and thus it can be seen that the working capacity is small.

TABLE 2

| | | | 100-400 kPa |
|---|---|---|---|
| | | Ion | Working Capacity |
| Sample | Result of | Exchange | (cc-CO₂/g- |
| No. | Analysis of Sample | Rate (%) | adsorbent ) |
| 11 | 100% NaY | 0 | 24.8 |
| 12 | 90% NaY/10% HY | 10 | 29.94 |
| 13 | 81% NaY/19% HY | 19 | 34.84 |
| 14 | 61% NaY/39% HY | 39 | 46.12 |
| 15 | 45% NaY/55% HY | 55 | 45.25 |
| 16 | 32% NaY/68% HY | 68 | 36.45 |
| 17 | 100% HY | 100 | 37.22 |

Table 2 above and FIG. 4 show working capacities in the pressure fluctuation section of 100 to 400 kPa according to degrees of ion exchange.

Sample 11, which had a degree of ion exchange of 0%, was 100% NaY and showed a working capacity of 24.8 cc/g in the pressure fluctuation range of 100 to 400 kPa. Meanwhile, it can be seen that Samples 14 and Samples 15, which had a degree of ion exchange of 39% to 55%, showed the relatively highest working capacity.

As discussed above, the adsorbent according to the present invention, the device and the method using the same can not only significantly improve the efficiency of the carbon dioxide pressure swing adsorption (PSA) process, but also reduce the size of the overall adsorption process device, thereby exhibits the effect of reducing costs.

The carbon dioxide adsorbent of the present invention can provide an adsorbent with excellent working capacities in a given pressure swing range by controlling a ratio of alkali metal cations or alkali earth metal cations to H⁺ (for example, Na⁺/H⁺) by ion-exchanging a part of alkali metal cations or alkali earth metal cations with H⁺ ions.

The Na⁺₁₋ₓH⁺ₓY-based adsorbent of the present invention has excellent working capacities and can be mixed with other commercially available adsorbents, and more efficient carbon dioxide separation can be performed when the adsorbent is mixed. The adsorbent can be easily adsorbed and desorbed under low temperature and pressure conditions, and the improvement of the adsorption rate can be achieved by providing heat when being mixed with a commercially available adsorbent having a high heat of adsorption.

The features, structures, effects, and the like described in the above-described examples are included in at least one example of the present invention and are not necessarily limited to only one example. Furthermore, the features, structures, effects, and the like illustrated in each example can be implemented in a combined or modified manner in other examples by a person with ordinary knowledge in the field to which the examples pertain. Therefore, contents related to such combinations and modifications should be construed as being included in the scope of the present invention.

In addition, the above description is mainly made on the examples, but the examples are provided for illustrative purposes only and do not limit the present invention, and it can be seen that a person with ordinary knowledge in the field to which the examples pertain will be able to make various modifications and applications not exemplified above without departing from the essential characteristics of the present examples. For example, each component specifically shown in the examples can be implemented in a modified manner. Also, these modifications and differences in application should be construed as being included in the scope of the present invention as defined in the attached claims.

What is claimed is:

1. A carbon dioxide adsorbent comprising:
X-type or Y-type zeolite in which at least a part of alkali metal cations or alkali earth metal cations is replaced with H⁺ ions.

2. The carbon dioxide adsorbent according to claim 1,
wherein the carbon dioxide adsorbent is expressed by Formula 1 or Formula 2,
[Formula 1] 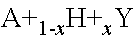
where A is alkali metal or alkali earth metal, and 0<x<1, and
[Formula 2] 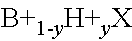
where B is alkali metal or alkali earth metal, and 0<y<1.

3. The carbon dioxide adsorbent according to claim 1, wherein the alkali metal cations or the alkali earth metal cations are Li ions, Na ions, K ions, Mg ions, or Ca ions.

4. The carbon dioxide adsorbent according to claim 1, wherein the Si/Al ratio of the carbon dioxide adsorbent is 1 to 100.

5. A device comprising:
a steam methane reforming (SMR) device for reforming methane into steam;
a water gas shift (WGS) device in which carbon monoxide-containing gas and steam provided from the SMR device react with each other;
a first pressure swing adsorption (PSA) device that separates carbon dioxide and hydrogen generated from the WGS device to generate high-purity hydrogen; and
a second pressure swing adsorption (PSA) device that collects carbon dioxide by being provided with carbon dioxide from at least one of the SMR device and the first PSA device,
wherein the second PSA device is filled with the carbon dioxide adsorbent, and
the carbon dioxide adsorbent includes X-type or Y-type zeolite in which at least a part of alkali metal cations or alkali earth metal cations is replaced with H⁺ ions.

6. The device according to claim 5,
wherein the carbon dioxide adsorbent is expressed by Formula 1 or Formula 2,
[Formula 1] 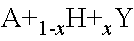
where A is alkali metal or alkali earth metal, and 0<x<1, and
[Formula 2] 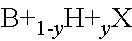
where B is alkali metal or alkali earth metal, and 0<y<1.

7. The device according to claim 5, wherein the alkali metal cations or the alkali earth metal cations are Li ions, Na ions, K ions, Mg ions, or Ca ions.

8. The device according to claim 5, wherein the Si/Al ratio of the carbon dioxide adsorbent is 1 to 100.

9. The device according to claim 5,
wherein the carbon dioxide adsorbent filled in the second PSA device includes
a first adsorbent including X-type or Y-type zeolite in which at least a part of alkali metal cations or alkali earth metal cations is replaced with H⁺ ions; and
a second adsorbent that is at least one of NaX and NaY.

10. A method comprising:
a steam methane reforming (SMR) process of reforming methane into steam;
a water gas shift (WGS) process in which carbon monoxide-containing gas and steam provided from the SMR device react with each other;
a first pressure swing adsorption (PSA) process for generating high-purity hydrogen by separating carbon dioxide and hydrogen generated from the WGS device; and
a second pressure swing adsorption (PSA) process for collecting carbon dioxide by being provided with carbon dioxide generated from at least one of the SMR process and the first PSA process,
wherein the carbon dioxide adsorbent is used in the second PSA process, and
the carbon dioxide adsorbent includes X-type or Y-type zeolite in which at least a part of alkali metal cations or alkali earth metal cations is replaced with H⁺ ions.

11. The method according to claim 10, wherein the carbon dioxide adsorbent is expressed by Formula 1 or Formula 2,
[Formula 1] 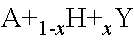
where A is alkali metal or alkali earth metal, and 0<x<1, and
[Formula 2] 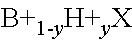
where B is alkali metal or alkali earth metal, and 0<y<1.

12. The method according to claim 10, wherein the alkali metal cations or the alkali earth metal cations are Li ions, Na ions, K ions, Mg ions, or Ca ions.

13. The method according to claim 10, wherein the Si/Al ratio of the carbon dioxide adsorbent is 1 to 100.

14. The method according to claim 10,
wherein the carbon dioxide adsorbent filled in the second PSA device includes
a first adsorbent including X-type or Y-type zeolite in which at least a part of alkali metal cations or alkali earth metal cations is replaced with H⁺ ions; and
a second adsorbent that is at least one of NaX and NaY.
